(19) United States
(12) Patent Application Publication
(10) Pub. No.: US 2026/0134662 A1
(43) Pub. Date: May 14, 2026

(54) OBJECT RECOGNITION DATA PROCESSING DEVICE FOR AUTONOMOUS VEHICLE AND METHOD THEREFOR

(71) Applicant: Industry Academic Cooperation Foundation of Yeungnam University, Gyeongsan-si (KR)

(72) Inventors: Seong Jin KWON, Gyeongsan-si (KR); Seung Lyong Jeong, Sejong-si (KR); Se Jong Kim, Yeongcheon-si (KR)

(73) Assignee: Industry Academic Cooperation Foundation of Yeungnam University, Gyeongsan-si (KR)

(21) Appl. No.: 19/386,531

(22) Filed: Nov. 12, 2025

(30) Foreign Application Priority Data
Nov. 13, 2024 (KR) 10-2024-0160737

(51) Int. Cl. G06V 10/764; G01S 17/931; G06V 10/40; G06V 10/82

(52) U.S. Cl. CPC G06V 10/764; G01S 17/931; G06V 10/40; G06V 10/82

(57) ABSTRACT

An object recognition data processing device for an autonomous vehicle according to the present disclosure comprises a LiDAR sensor configured to generate distance information by measuring a time it takes for laser pulses to be reflected and returned from a nearby object to which the laser pulses are emitted, and convert the distance information into raw point cloud data; an autonomous driving controller configured to provide the raw point cloud data; and a computing module mounted on the autonomous vehicle in the form of an embedded board and configured to process the raw point cloud data to generate and store object recognition data upon receiving the raw point cloud data from the autonomous driving controller, and provide the object recognition data to a control center server.

### CROSS-REFERENCE TO RELATED APPLICATION

The present application claims priority to and the benefit of Korean Patent Application No. 10-2024-0160737, filed on Nov. 13, 2024 in the Korean Intellectual Property Office, the entire disclosure of which is incorporated herein by reference.

### TECHNICAL FIELD

The present disclosure relates to an object recognition data processing device for an autonomous vehicle and a method therefor, and more specifically, to an object recognition data processing device for an autonomous vehicle comprising a separate device in the form of an embedded board that stores raw data acquired from a LiDAR sensor, thereby enabling object recognition to be performed based on the data acquired from the LiDAR sensor, and a method therefor.

This research was supported by the Gyeongsangbuk-do RISE (Regional Innovation System& Education) project [000 unit].

### BACKGROUND

Autonomous driving technology is a technology for enabling a vehicle to recognize and determine a road environment and control driving by itself, in which objects and obstacles surrounding the vehicle need to be recognized and responded to through various sensors and algorithms in real time.

In particular, a light detection and ranging (LiDAR) sensor is a key sensor in an autonomous vehicle, and provides high-resolution 3D spatial information of surroundings of the vehicle. This LiDAR sensor primarily emits laser pulses, receives a reflected signal to calculate a distance, and represents a position and shape of a nearby object in the form of raw 3D point cloud data (a point cloud) based on the distance.

However, raw point cloud data obtained from a large number of LiDAR sensors is extremely massive data, posing a significant burden on real-time processing. The raw point cloud data consists of millions of points, each including not only spatial coordinates but also reflection intensity, time information, and the like, resulting in a significant volume of data. This massive data overloads an autonomous driving control system in a vehicle and greatly affects real-time data processing performance.

An existing autonomous driving system mainly uses a scheme for transferring all data collected from LiDAR sensors to an autonomous driving controller and then filtering unnecessary data through the autonomous driving controller to recognize an object. However, this scheme causes the following problems.

First, the autonomous driving controller needs to process a vast amount of data inside the vehicle, and raw point cloud data provided by the LiDAR sensors occupies a significant portion of the data. Processing such massive data in real time requires high-performance hardware, and a low processing speed may negatively affect the safety and driving performance of the autonomous vehicle.

Second, the raw point cloud data collected from the LiDAR sensors contains a lot of unnecessary information (for example, the sky, small stones on a road surface, and distant objects unrelated to the vehicle) in addition to information essential for object recognition. Processing all unnecessary information wastes computational resources and makes it difficult to quickly extract only necessary information.

Third, a structure of processing all data and performing object recognition in the autonomous driving controller increases system complexity and increases hardware and software development costs. This complexity also increases the likelihood of system errors and increases difficulty in maintenance.

Fourth, an autonomous vehicle is a system that requires high responsiveness and needs to respond quickly to surroundings. However, delay in processing all LiDAR data may cause a problem with real-time responsiveness. This increases a likelihood that the autonomous vehicle will not be able to respond appropriately to unexpected situations, causing accidents.

As described above, for enhancement of the completeness of an autonomous vehicle, it is important for the vehicle to accurately recognize surroundings and perform accurate determination and control for driving based on the recognition.

To this end, advanced recognition technology utilizing surround sensors (such as cameras, radars, and LiDARs) is essential, and this recognition technology relies heavily on the quality of artificial intelligence training data used in the autonomous driving system. LiDAR sensors, in particular, provide high-resolution raw 3D point cloud data, enabling autonomous vehicles to accurately recognize nearby objects.

However, current autonomous driving systems have difficulty in processing massive raw data collected by LiDAR sensors in real time. Since a LiDAR sensor generates more than about 70 MB of data per second, processing all the data in the autonomous driving controller increases a computational burden.

Therefore, an existing system integrates LiDAR data with other sensors (for example, cameras and radars) to perform sensor fusion, removes unnecessary data for driving, and leaves only important data. In such a process, there is a problem that raw LiDAR data is removed and no accurate object recognition data obtained by utilizing the raw LiDAR data remains.

For commercialization of autonomous driving of Level 3 or higher, it is necessary to be able to integrate and manage object information and traffic situation data around a vehicle collected in real time in connection with a control center. However, information currently provided to the control center is limited to vehicle status data (PVD) or snapshot-type video data, and there is a lack of data provision that accurately reflects nearby objects and traffic situations.

### SUMMARY

An object of the present disclosure is to provide an object recognition data processing device for an autonomous vehicle and a method therefor that extract and store only necessary object recognition information in a separate preprocessing system, instead of an autonomous driving controller processing all of massive data collected by LiDAR sensors, thereby greatly reducing a computational burden on the autonomous driving controller, enhancing real-time performance, and increasing the efficiency of an autonomous driving system.

Another object of the present disclosure is to provide an object recognition data processing device for an autonomous vehicle and a method therefor that extract only object information from LiDAR data, and store and provide the object information in real time, thereby enhancing object recognition accuracy and contributing to more precise recognition of surroundings of the autonomous vehicle.

Yet another object of the present disclosure is to provide an object recognition data processing device for an autonomous vehicle and a method therefor that provide preprocessed object recognition data to a control center in real time, thereby enabling real-time management of event situations such as a road traffic situation, traffic flow, and accidents, and enhancing the safety and responsiveness of an autonomous driving system.

Yet another object of the present disclosure is to provide an object recognition data processing device for an autonomous vehicle and a method therefor that enable more accurate training of a recognition algorithm for an autonomous driving system by utilizing stored object recognition data as artificial intelligence training data for advanced autonomous driving, and provide a foundation for further development of autonomous driving technology.

Yet another object of the present disclosure is to provide an object recognition data processing device for an autonomous vehicle and a method therefor that can store and provide not only LiDAR data but also GPS real-time kinematic (RTK) data and vehicle status data (PVD) to contribute to the commercialization of autonomous driving by strengthening a linkage between vehicle data and road infrastructure.

The objects of the present disclosure are not limited to the aforementioned objectives, and other objects and advantages of the present disclosure that are not mentioned above can be understood through the following description and will be more clearly understood through the embodiments of the present disclosure. Further, it will be readily understood that the objects and advantages of the present disclosure can be realized by the means set forth in the claims and combinations thereof.

To achieve the objects, an object recognition data processing device for an autonomous vehicle comprises a LiDAR sensor configured to generate distance information by measuring a time it takes for laser pulses to be reflected and returned from a nearby object to which the laser pulses are emitted, and convert the distance information into raw point cloud data; an autonomous driving controller configured to provide the raw point cloud data; and a computing module mounted on the autonomous vehicle in the form of an embedded board and configured to process the raw point cloud data to generate and store object recognition data upon receiving the raw point cloud data from the autonomous driving controller, and provide the object recognition data to a control center server.

In an embodiment, the computing module may group points for the raw point cloud data to form an object, extract features of the object, identify a type of object using a deep learning model, and then store the type of object as the object recognition data.

In an embodiment, the computing module may apply a density-based spatial clustering of applications with noise algorithm to the raw point cloud data to define an outline of the object, and store a shape, size, and relative position of the object as the object recognition data.

To achieve the objects, a method of processing object recognition data for an autonomous vehicle comprises generating, by a LiDAR sensor, distance information by measuring a time it takes for laser pulses to be reflected and returned from a nearby object to which the laser pulses are emitted, and converting the distance information into raw point cloud data; receiving, by an autonomous driving controller, the raw point cloud data from the LiDAR sensor and providing the raw point cloud data to a computing module mounted on the autonomous vehicle in the form of an embedded board; processing, by a computing module, the raw point cloud data to generate and store object recognition data upon receiving the raw point cloud data from the autonomous driving controller; and providing, by the computing module, the object recognition data to a control center server.

In an embodiment, the processing of the raw point cloud data to generate and store object recognition data may comprise grouping points for the raw point cloud data to form an object; and extracting features of the object, identifying a type of object using a deep learning model, and then storing the type of object as the object recognition data.

In an embodiment, the processing of the raw point cloud data to generate and store object recognition data may comprise applying a density-based spatial clustering of applications with noise algorithm to the raw point cloud data to define an outline of the object, and storing a shape, size, and relative position of the object as the object recognition data.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a network diagram illustrating an object recognition data processing system for an autonomous vehicle according to an embodiment of the present disclosure;

FIG. 2 is a network configuration diagram illustrating an internal structure of the object recognition data processing device for an autonomous vehicle according to the embodiment of the present disclosure;

FIG. 3 is a block diagram illustrating an internal structure of the object recognition data processing device for an autonomous vehicle; and

FIG. 4 is a flowchart illustrating an embodiment of a method of processing object recognition data for an autonomous vehicle according to the present disclosure.

### DETAILED DESCRIPTION OF EXEMPLARY EMBODIMENTS

The above-described objects, signatures, and advantages will be described in detail below with reference to the accompanying drawings, thereby enabling those skilled in the art to readily implement the technical spirit of the present disclosure. In describing the present disclosure, detailed description of known technologies related to the present disclosure will be omitted when the description is deemed to unnecessarily obscure the gist of the present disclosure. Hereinafter, preferred embodiments of the present disclosure will be described in detail with reference to the accompanying drawings. In the drawings, the same or similar components are denoted by the same reference numerals.

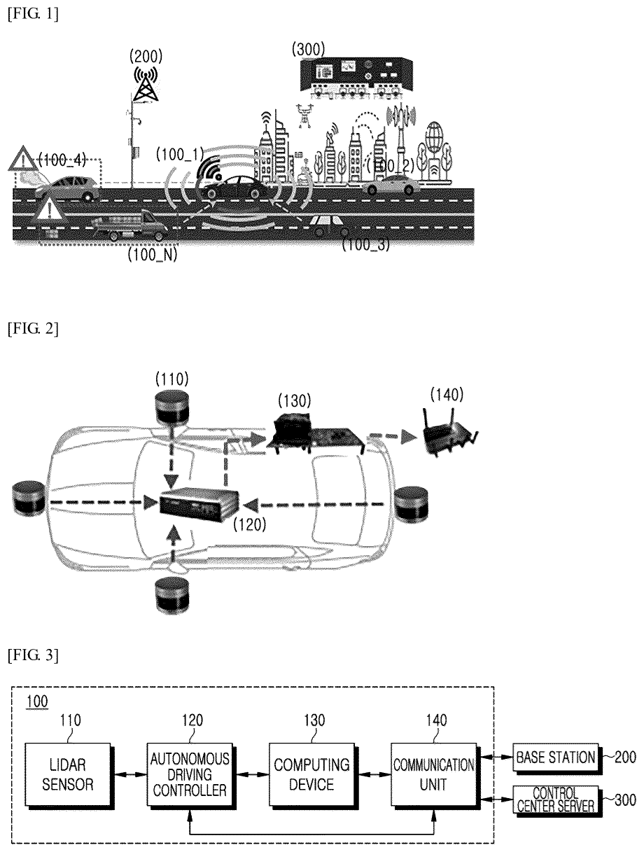

FIG. 1 is a network configuration diagram illustrating an object recognition data processing system for an autonomous vehicle according to an embodiment of the present disclosure.

Referring to FIG. 1, the object recognition data processing system for an autonomous vehicle comprises autonomous vehicles 100_1 to 100_N, a base station 200, and a control center server 300.

The autonomous vehicle 100_1 processes raw data through a separate device in the form of an embedded board, and recognizes and classifies objects around the autonomous vehicle 100_1 in real time.

The autonomous vehicle 100_1 collects raw data in the form of raw point cloud data through LiDAR sensor data and provides the raw data to a computing module in the form of an embedded board formed in the autonomous vehicle 100_1. Accordingly, the computing module preprocesses the raw data to remove noise and extract features (size, position, reflection intensity, and the like) of the object.

Based on the preprocessed data, the computing module recognizes all objects surrounding the autonomous vehicle 100_1 and ascertains information such as a position, size, direction of movement, and speed of each object to classify features of the object. In this case, the computing module stores object information on the embedded board, enabling the autonomous vehicle system to utilize the object recognition data.

In an embodiment, the computing module provides preprocessed object information to the base station 200 via an on-board unit (OBU). This communication is performed via a cellular vehicle-to-everything (C-V2X) or wireless access in vehicular environment (WAVE) technology, and the base station 200 transfers the object recognition data transmitted by the autonomous vehicle 100_1 to the control center server 300 in real time.

When the base station 200 receives the object recognition data, traffic status information, and vehicle position information transmitted by the autonomous vehicle 100_1 through two-way communication with the OBU of the autonomous vehicle 100_1, the base station 200 provides these to the control center server 300.

The base station 200 transmits traffic information or risk factors analyzed by the control center to other nearby autonomous vehicles to assist the other vehicles in making a safe driving determination. For example, the base station 200 may transfer information on an accident that has occurred in a specific section to the other vehicles, so that the other vehicles can slow down or change their routes.

Further, the base station 200 may collect and transfer real-time traffic information in conjunction with road infrastructure such as traffic lights, road signs, and traffic cameras. This makes safer and more efficient management of a road environment possible.

Further, the base station 200 provides position-based services based on vehicle position data. For example, the base station 200 collects vehicle GPS information to analyze and share a traffic situation at a specific position in real time. This allows the base station 200 to detect traffic congestion in a specific area and send a warning message or suggest a detour to the nearby autonomous vehicles 100_2 to 100_N.

Furthermore, the base station 200 may recognize risk factors based on information received from the autonomous vehicle 100_1 and the control center server 300 and transmit a safety warning message to the nearby autonomous vehicles 100_2 to 100_N. For example, the base station 200 may propagate real-time information on a vehicle that suddenly stops ahead, obstacles on roads, and pedestrian intrusions, thereby contributing to accident prevention.

The control center server 300 integrates various types of object recognition data, traffic status information, and position information of the autonomous vehicle 100_1 collected through the base station 200 to analyze a real-time traffic situation. For example, the control center server 300 can collect information on road obstacles and accidents to optimize a traffic flow or immediately respond to emergencies.

The control center server 300 collects traffic information transmitted from the base station 200 and the autonomous vehicle 100_1 in real time and monitors an overall road situation. For example, the control center server 300 analyzes information such as traffic congestion areas, accident positions, vehicle movement paths, and road obstacles to ascertain a real-time traffic status. Such a monitoring function supports vehicles on a road so that the vehicles can safely travel and enables the vehicles to rapidly detect unexpected situations occurring in specific areas.

Further, the control center server 300 analyzes data collected in real time to identify risk factors such as traffic accidents, road obstacles, and emergencies, and immediately notifies the autonomous vehicle 100_1 of the risk factors to prevent accidents. For example, when an obstacle suddenly appears or an accident suddenly occurs on a road, the control center server 300 transfers this fact to the nearby autonomous vehicle 100_1 and the base station 200, thereby enabling the nearby autonomous vehicles 100_2 to 100_N to respond quickly.

Further, the control center server 300 analyzes road congestion and suggests optimal routes to the vehicles to optimize a traffic flow. When congestion is expected in a high-traffic section or during a specific time period, the control center server 300 suggests an alternative route or adjusts vehicle speed to alleviate traffic congestion. This makes it possible to obtain effects of supporting a smooth traffic flow throughout an entire road network and reducing travel time.

Further, the control center server 300 manages the object recognition data received from the base station 200 and the autonomous vehicle 100_1 and distributes necessary object information to the nearby autonomous vehicles 100_2 to 100_N to support cooperative driving among the autonomous vehicles 100_1. For example, the control center server 300 provides object recognition data for pedestrians, other vehicles, obstacles, and the like on the road to the respective autonomous vehicles 100_1 to 100_N, so that the autonomous vehicles 100_1 to 100_N can drive while maintaining a safe distance. This allows the nearby autonomous vehicles 100_2 to 100_N to predict a road situation and prevent accident risks in advance.

Further, the control center server 300 expands a traffic management function through integration with road infrastructure such as traffic signal systems, road signs, and CCTV. When traffic volume increases rapidly at a specific intersection, the control center server 300 can adjust signals to smooth a vehicle flow and enhance pedestrian safety. By additionally analyzing visual data through videos of CCTVs or traffic cameras on roads, it is possible to identify situations that are difficult to ascertain with vehicle sensor information.

FIG. 2 is a network configuration diagram illustrating an internal structure of the object recognition data processing device for an autonomous vehicle according to the embodiment of the present disclosure. FIG. 3 is a block diagram illustrating an internal structure of the object recognition data processing device for an autonomous vehicle.

Referring to FIGS. 2 and 3, the autonomous vehicles 100_1 to 100_N comprise a LiDAR sensor 110, an autonomous driving controller 120, and a computing device 130.

The LiDAR sensor 110 emits laser pulses, measures a time it takes for the pulses to be reflected and returned from a nearby object, and calculates a distance to the object. This is called time of flight (ToF), and since the speed of light is known, the distance can be accurately measured based on the time it takes for the pulse to be emitted and returned.

In an embodiment, when the LiDAR sensor 110 rapidly emits laser light in several directions and receives the laser light reflected by and returned from an object, the LiDAR sensor 110 measures a time it takes for the laser light to reach the object and the reflected light to be returned to the LiDAR sensor 110, to calculate the distance to the object.

In the embodiment, the LiDAR sensor 110 converts distance information collected through numerous laser pulses and reflections thereof into three-dimensional data called raw point cloud data. This data enables the autonomous vehicle to recognize surroundings in 3D. The raw point cloud data is very high-resolution raw data collected directly by the LiDAR sensor and is a set of numerous points including information on objects around the vehicle, distances, and positions.

The raw data is very large volume data, and the autonomous driving controller 120 has a large computational burden for processing all the data in real time. An amount of data generated by the LiDAR sensor may exceed 70 MB per second, causing problems with processing and storing of large volume data.

When the autonomous driving controller 120 receives the raw data from the LiDAR sensor 110, the autonomous driving controller 120 transmits the raw data to the separate device in the form of an embedded board. In this process, GPS real-time kinematic (RTK) data and vehicle status data (PVD) may also be included depending on a demand, in addition to the LiDAR data.

The GPS RTK data is a technology for providing highly accurate position information and is used to track a position of an autonomous vehicle in real time. The RTK GPS typically provides position accuracy within a few centimeters, making the RTK GPS essential for an autonomous driving system.

The vehicle status data is data representing a physical status of a vehicle, such as speed, acceleration, steering angle, and braking status of the vehicle. This data is used to ascertain a current driving status of the vehicle and support safe and efficient operation.

The separate device in the form of an embedded board is a dedicated computing module 130 mounted within the autonomous vehicle. The computing module 130 preprocesses the raw LiDAR data received from the autonomous driving controller in real time.

The computing module 130 determines whether or not there is an object using the raw point cloud data from the autonomous driving controller 120 and classifies the object.

First, the computing module 130 performs filtering on the raw point cloud data. Specifically, the raw point cloud data may contain noise caused by external factors or sensor errors. Therefore, the computing module 130 uses a filtering algorithm to remove this noise.

In an embodiment, the computing module 130 also removes points that are a certain distance away (for example, distant background objects) or abnormal points (for example, abnormal values due to sensor errors) from the raw point cloud data.

The computing module 130 segments the raw point cloud data into individual objects. This is a process of grouping closely located points to form individual objects. For example, a density-based spatial clustering of applications with noise (DBSCAN) algorithm may be used.

In an embodiment, the computing module 130 applies the DBSCAN algorithm to the raw point cloud data, thereby analyzing a shape based on points of a cluster and defining an outline of the object. This makes it possible for the computing module 130 to check a shape, size, and relative position of the object.

In another embodiment, the computing module 130 separates the object and a background and then applies a voxel grid filter to perform downsampling. The raw point cloud data consists of millions of 3D points like LiDAR data collected from the autonomous vehicle, and since processing such massive data in real time imposes a heavy computational burden, the voxel grid filter is used to simplify the data and leave only the necessary information.

The downsampling is a process of removing unnecessary or redundant data while maintaining important information instead of simply reducing data. For example, objects on which detailed information is not necessary due to being far from a vehicle can be represented by a smaller number of points. In this process, the data is divided into a grid structure using a technique such as a voxel grid filter, and then only a representative point within each grid is selected to reduce a size of the data.

First, the computing module 130 divides a 3D space where the cloud data exists into small 3D cubes (a grid). Here, a 3D cube is a voxel and is a hexahedron with a fixed size, and the 3D space is divided according to a user-designated resolution (voxel size). In this case, when the size of the voxel is smaller, more detailed data is retained, and when the size of the voxel is larger, more data is removed.

After division of the 3D space into voxels, the computing module 130 confirms all points within each of the voxels and analyzes all the points within the voxels to select a representative point.

In an embodiment, the computing module 130 determines a specific point within the voxel as a representative point based on the reflection intensity of the raw LiDAR point cloud data. In this case, the computing module 130 may select the representative point according to [Formula 1].

$$\begin{matrix}[ Formula 1 ] & \\ \text{?} {p}_{i , selected} - {arg max}_{{p}_{ij} ∈ {P}_{i}} {I}_{ij} & \end{matrix}$$

$$\text{?} \text{indicates text missing or illegible when filed}$$

P_{i,selected}: Point with maximum reflection intensity within Vᵢ,
Vᵢ: Voxel,
Pᵢ: {Pᵢ₁, Pᵢ₂, . . . , Pᵢₙ}, and
Iᵢⱼ: Reflection intensity of each point Pᵢⱼ.

The computing module 130 finds the point Pᵢⱼ with the highest reflection intensity within each voxel Vᵢ, as shown in [Formula 1], and then removes all points except the selected point P_{i, selected} for each voxel Vᵢ. Thus, only points with high reflection intensity are selected as representative points within each voxel.

This is because the data collected by the LiDAR sensor comprises reflection intensity information, the points with high reflection intensity primarily represent a surface of an object, and points with low reflection intensity are highly likely to represent a background. Therefore, the computing module 130 may use a method of preferentially selecting the points with high reflection intensity as the representative points.

In another embodiment, the computing module 130 determines a specific point within the voxel as a representative point based on a height of the raw LiDAR point cloud data. In this case, the computing module 130 may select the representative point according to [Formula 2].

$$\begin{matrix}[ Formula 2 ] & \\ \text{?} {P}_{i , filtered} = \{ {p}_{ij} ∈ {P}_{i} \vert {H}_{ij} \geq {H}_{min} \} & \end{matrix}$$

$$\text{?} \text{indicates text missing or illegible when filed}$$

P_{i,filtered}: A set of points whose heights satisfy a minimum criterion,
Vᵢ: Voxel,
Hᵢⱼ: Height of Pᵢⱼ (that is, Z-coordinate), and
Pᵢⱼ: {Pᵢ₁, Pᵢ₂, . . . , Pᵢₙ}

That is, the computing module 130 may extract a set of points whose heights satisfy a minimum criterion within each voxel Vᵢ, as shown in [Formula 2], and then select, as representative points, average coordinates of the points satisfying the height criterion, as shown in [Formula 3] in a set P_{i,filtered} of points.

$$\begin{matrix}[ Formula 3 ] & \\ \text{?} {p}_{i , selected} = \frac{1}{\vert {P}_{i , filtered} \vert} {\sum }_{{p}_{ij} ∈ {P}_{i , filtered}} {p}_{ij} & \end{matrix}$$

$$\text{?} \text{indicates text missing or illegible when filed}$$

P_{i,selected}: Average coordinates of points whose heights satisfy a minimum criterion,
Pᵢⱼ: {Pᵢ₁, Pᵢ₂, . . . , Pᵢₙ}, and
P_{i,filtered}: A set of points whose heights satisfy the minimum criterion.

This is because, when background (for example, a road) and an object (for example, a vehicle or a person) can be distinguished primarily based on a height difference from the ground, only points with a certain height or more within each voxel can be selected as representative points. This is useful for recognizing and removing portions parallel to the ground as background.

The computing module 130 then converts the collected raw point cloud data into a coordinate system of the vehicle. This is because the data from the LiDAR sensor is measured based on a position at which the sensor is installed, and the data needs to be converted according to a world coordinate system or map coordinate system of the autonomous vehicle.

Therefore, the computing module 130 applies rotation and translation to convert coordinates of each point collected by the LiDAR sensor into a reference coordinate system of the vehicle. This makes integrated recognition possible by combining the LiDAR data with data collected from other sensors (cameras, radar, and the like).

The computing module 130 distinguishes different objects in the raw point cloud data.

First, the computing module 130 groups spatially close points into a single object using a clustering technique. A representative clustering technique such as a Euclidean clustering or RANSAC algorithm is used. In Euclidean clustering, points within a specific radius are grouped into a single cluster based on distances between the points, and RANSAC is useful for identifying and removing flat surfaces such as roads or walls.

The computing module 130 then extracts features of the object from each cluster.

In an embodiment, the computing module 130 calculates a difference between minimum and maximum coordinates of the object using a bounding box, as in [Formula 4], to obtain a size of the object in the raw LiDAR point cloud data.

$$\begin{matrix}[ Formula 4 ] & \\ L = {x}_{max} - {x}_{min} & 1\end{matrix}$$

$$W = {y}_{max} - {y}_{min} \qquad 2$$

$$\text{?} H = {z}_{max} - {z}_{min} \qquad 3$$

$$\text{?} \text{indicates text missing or illegible when filed}$$

L: Length of the object,
W: Width of the object,
H: Height of the object,
xₘₐₓ: Maximum value of an x-coordinate of the object,
xₘᵢₙ: Minimum value of the x-coordinate of the object,
yₘₐₓ: Maximum value of a y-coordinate of the object,
yₘᵢₙ: Minimum value of the y-coordinate of the object,
zₘₐₓ: Maximum value of a z-coordinate of the object, and
zₘᵢₙ: Minimum value of the z-coordinate of the object.

In the embodiment, the computing module 130 can surround a space occupied by the points of each object in the form of a bounding box and calculate a size of each object through the bounding box.

Further, the computing module 130 may calculate the average of each coordinate to determine a center point, as in [Formula 5].

$$\begin{matrix}[ Formula 5 ] & \\ {x}_{c} = \frac{1}{n} {\sum }_{i = 1}^{n} {x}_{i} & 1\end{matrix}$$

$${y}_{c} = \frac{1}{n} {\sum }_{i = 1}^{n} {y}_{i} \qquad 2$$

$$\text{?} {z}_{c} = \frac{1}{n} {\sum }_{i = 1}^{n} {z}_{i} \qquad 3$$

$$\text{?} \text{indicates text missing or illegible when filed}$$

n: Number of raw point cloud data points, and
(x_{c}, y_{c}, z_{c}): Center point.

Further, the computing module 130 estimates a movement speed and direction of the object using the raw point cloud data of several frames. In this case, the computing module 130 calculates velocity and direction vectors of the object based on the movement of the center point of the raw point cloud data of several frames according to [Formula 5] to [Formula 7].

That is, the computing module 130 calculates a change between center points

$$\text{?} ( {x}_{c}^{( t )} , {y}_{c}^{( t )} , {z}_{c}^{( t )} ) and ( {x}_{c}^{( t + 1 )} , {y}_{c}^{( t + 1 )} , {z}_{c}^{( t + 1 )} )$$

$$\text{?} \text{indicates text missing or illegible when filed}$$

of the raw point cloud data in consecutive frames.

$$\begin{matrix}[ Formula 6 ] & \\ \text{?} Δ c = ( {x}_{c}^{( t + 1 )} - {x}_{c}^{( t )} , {y}_{c}^{( t + 1 )} - {y}_{c}^{( t )} , {z}_{c}^{( t + 1 )} - {z}_{c}^{( t )} ) , & \end{matrix}$$

$$\text{?} \text{indicates text missing or illegible when filed}$$

Δc: Motion vector,

$$\text{?} ( {x}_{c}^{( t )} , {y}_{c}^{( t )} , {z}_{c}^{( t )} ) :$$

$$\text{?} \text{indicates text missing or illegible when filed}$$

Center point of the raw point cloud data in a first frame,

$$\text{?} ( {x}_{c}^{( t + 1 )} , {y}_{c}^{( t + 1 )} , {z}_{c}^{( t + 1 )} ) :$$

$$\text{?} \text{indicates text missing or illegible when filed}$$

Center point of the raw point cloud data in a second frame,

$$\begin{matrix}[ Formula 7 ] & \\ \text{?} v = \frac{Δ c}{Δ t} = ( \frac{{x}_{c}^{( t + 1 )} - {x}_{c}^{( t )}}{Δ t} , \frac{{y}_{c}^{( t + 1 )} - {y}_{c}^{( t )}}{Δ t} , \frac{{z}_{c}^{( t + 1 )} - {z}_{c}^{( t )}}{Δ t} ) , & \end{matrix}$$

$$\text{?} \text{indicates text missing or illegible when filed}$$

V: Velocity,
Δc: Motion vector,
Δt: Time interval,

$$\text{?} ( {x}_{c}^{( t )} , {y}_{c}^{( t )} , {z}_{c}^{( t )} ) :$$

$$\text{?} \text{indicates text missing or illegible when filed}$$

Center point of the raw point cloud data in the first frame, and

$$\text{?} ( {x}_{c}^{( t + 1 )} , {y}_{c}^{( t + 1 )} , {z}_{c}^{( t + 1 )} ) :$$

$$\text{?} \text{indicates text missing or illegible when filed}$$

Center point of the raw point cloud data in the second frame,

$$\begin{matrix}[ Formula 8 ] & \\ \text{?} d = \frac{Δ c}{‖ Δ c ‖} , & \end{matrix}$$

$$\text{?} \text{indicates text missing or illegible when filed}$$

d: Movement direction, and
Δc: Motion vector.

The computing module 130 then calculates reflection intensity of an i-th point within the object according to [Formula 9].

$$\begin{matrix}[ Formula 9 ] & \\ \text{?} {I}_{avg} = \frac{1}{n} {\sum }_{i = 1}^{n} {I}_{i} & \end{matrix}$$

$$\text{?} \text{indicates text missing or illegible when filed}$$

I_{avg}: Average value of the reflection intensity

As described above, the computing module 130 extracts features of the object, identifies a type of object each cluster represents using a machine learning or deep learning model, and then stores only object information.

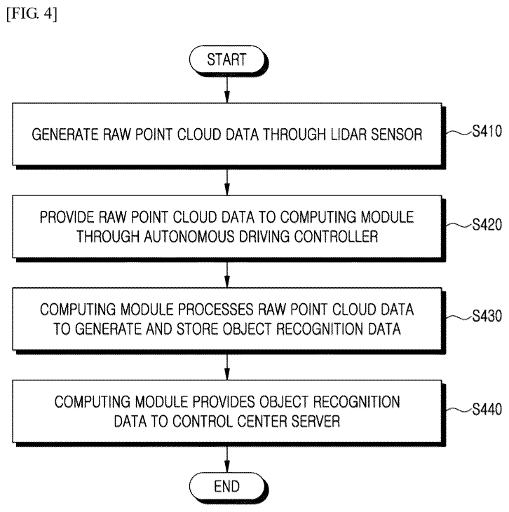

FIG. 4 is a flowchart illustrating an embodiment of a method of processing object recognition data for an autonomous vehicle according to the present disclosure.

Referring to FIG. 4, a LiDAR sensor generates distance information by measuring a time it takes for laser pulses to be reflected and returned from a nearby object to which the laser pulses are emitted, and converts the distance information into raw point cloud data (operation S410).

The autonomous driving controller receives the raw point cloud data from the LiDAR sensor and provides the raw point cloud data to a computing module mounted on the autonomous vehicle in the form of an embedded board (operation S420).

The computing module processes the raw point cloud data to generate and store object recognition data upon receiving the raw point cloud data from the autonomous driving controller (operation S430).

In an embodiment of operation S430, the computing module groups points for the raw point cloud data to form an object, extracts features of the object, identifies a type of object using a deep learning model, and then stores the type of object as the object recognition data.

In another embodiment of operation S430, the computing module applies the DBSCAN algorithm to the raw point cloud data to define an outline of the object and stores a shape, size, and relative position of the object as the object recognition data.

The computing module provides the object recognition data to the control center server (operation S440).

As described above, the present disclosure has the advantage of extracting and storing only necessary object recognition information in a separate preprocessing system, instead of an autonomous driving controller processing all of massive data collected by LiDAR sensors, thereby greatly reducing a computational burden on the autonomous driving controller, enhancing real-time performance, and increasing the efficiency of an autonomous driving system.

Further, the present disclosure has the advantage of extracting only object information from LiDAR data, and storing and providing the object information in real time, thereby enhancing object recognition accuracy and contributing to more precise recognition of surroundings of the autonomous vehicle.

Furthermore, the present disclosure has the advantage of providing preprocessed object recognition data to a control center in real time, thereby enabling real-time management of event situations such as road traffic situation, traffic flow, and accidents, and enhancing the safety and responsiveness of an autonomous driving system.

Further, the present disclosure has the advantage of enabling more accurate training of a recognition algorithm for an autonomous driving system by utilizing stored object recognition data as artificial intelligence training data for advanced autonomous driving, and providing a foundation for further development of autonomous driving technology.

Furthermore, the present disclosure has the advantage of storing and providing not only LiDAR data but also GPS RTK data and vehicle status data (PVD) to contribute to the commercialization of autonomous driving by strengthening a linkage between vehicle data and road infrastructure.

While the present disclosure has been described with reference to the above-described embodiments and drawings, the present disclosure is not limited to the above-described embodiments, and various modifications and variations can be made from the description by those skilled in the art. Therefore, the spirit of the present disclosure should be understood solely based on the claims set forth below, and all equal or equivalent modifications thereof are deemed to fall within the spirit of the present disclosure.

What is claimed is:

1. An object recognition data processing device for an autonomous vehicle, comprising:
a LiDAR sensor configured to generate distance information by measuring a time it takes for laser pulses to be reflected and returned from a nearby object to which the laser pulses are emitted, and convert the distance information into raw point cloud data;
an autonomous driving controller configured to provide the raw point cloud data; and
a computing module mounted on the autonomous vehicle in the form of an embedded board and configured to process the raw point cloud data to generate and store object recognition data upon receiving the raw point cloud data from the autonomous driving controller, and provide the object recognition data to a control center server.

2. The object recognition data processing device for an autonomous vehicle of claim 1, wherein the computing module groups points for the raw point cloud data to form an object, extracts features of the object, identifies a type of object using a deep learning model, and then stores the type of object as the object recognition data.

3. The object recognition data processing device for an autonomous vehicle of claim 2, wherein the computing module applies a density-based spatial clustering of applications with noise algorithm to the raw point cloud data to define an outline of the object, and stores a shape, size, and relative position of the object as the object recognition data.

4. A method of processing object recognition data for an autonomous vehicle, the method comprising:
generating, by a LiDAR sensor, distance information by measuring a time it takes for laser pulses to be reflected and returned from a nearby object to which the laser pulses are emitted, and converting the distance information into raw point cloud data;
receiving, by an autonomous driving controller, the raw point cloud data from the LiDAR sensor and providing the raw point cloud data to a computing module mounted on the autonomous vehicle in the form of an embedded board;
processing, by a computing module, the raw point cloud data to generate and store object recognition data upon receiving the raw point cloud data from the autonomous driving controller; and
providing, by the computing module, the object recognition data to a control center server.

5. The method of processing object recognition data for an autonomous vehicle of claim 4, wherein the processing of the raw point cloud data to generate and store object recognition data comprises:
grouping points for the raw point cloud data to form an object; and
extracting features of the object, identifying a type of object using a deep learning model, and then storing the type of object as the object recognition data.

6. The method of processing object recognition data for an autonomous vehicle of claim 4, wherein the processing of the raw point cloud data to generate and store object recognition data comprises applying a density-based spatial clustering of applications with noise algorithm to the raw point cloud data to define an outline of the object, and storing a shape, size, and relative position of the object as the object recognition data.
